(19) United States
(12) Patent Application Publication
(10) Pub. No.: US 2025/0383775 A1
(43) Pub. Date: Dec. 18, 2025

(54) MULTI-PORT MEMORY SYSTEM HOST MEMORY BUFFERS

(71) Applicant: Micron Technology, Inc., Boise, ID (US)

(72) Inventor: Marco Redaelli, München (DE)

(21) Appl. No.: 19/236,250

(22) Filed: Jun. 12, 2025

Related U.S. Application Data
(60) Provisional application No. 63/661,331, filed on Jun. 18, 2024.

(51) Int. Cl. G06F 3/06

(52) U.S. Cl. CPC G06F 3/0611; G06F 3/0656; G06F 3/0679

(57) ABSTRACT

The disclosure configures a multi-port memory sub-system controller to store data in one or more host memory buffers. The disclosure associates, with a first port of a memory sub-system, a first host memory buffer (HMB) of a first temporary storage device that has been allocated to the memory sub-system by a first host system of a plurality of host systems and associates, with a second port of the memory sub-system, a second HMB of a second temporary storage device that has been allocated to the memory sub-system by a second host system of the plurality of host systems. The disclosure performs one or more memory operations on user data using the first HMB and the second HMB and a set of memory components.

### PRIORITY APPLICATION

This application claims the benefit of priority to U.S. Provisional Application Ser. No. 63/661,331, filed Jun. 18, 2024, which is incorporated herein by reference in its entirety.

### TECHNICAL FIELD

Examples of the disclosure relate generally to memory sub-systems and, more specifically, to providing adaptive media management for memory components, such as memory dies.

### BACKGROUND

A memory sub-system can be a storage system, such as a solid-state drive (SSD), and can include one or more memory components that store data. The memory components can be, for example, non-volatile memory components and volatile memory components. In general, a host system can utilize a memory sub-system to store data on the memory components and to retrieve data from the memory components.

### BRIEF DESCRIPTION OF THE DRAWINGS

The present disclosure will be understood more fully from the detailed description given below and from the accompanying drawings of various examples of the disclosure.

FIG. 1 is a block diagram illustrating an example computing environment including a memory sub-system, in accordance with some examples.

FIG. 2 is a block diagram of an example multi-port memory sub-system, in accordance with some examples.

FIG. 3 is a block diagram of an example virtual address space of the memory sub-system, in accordance with some examples.

FIG. 4 is a flow diagram of an example method to perform memory operations using a virtual address space of a memory sub-system, in accordance with some examples.

FIG. 5 is a block diagram illustrating a diagrammatic representation of a machine in the form of a computer system within which a set of instructions can be executed for causing the machine to perform any one or more of the methodologies discussed herein, in accordance with some examples.

### DETAILED DESCRIPTION

Examples of the present disclosure configure a system component, such as a memory sub-system controller, to dynamically perform memory operations using a plurality of host memory buffers (HMBs) of a plurality of host systems coupled to the memory sub-system. Specifically, the disclosed techniques can couple a single memory sub-system (e.g., solid state storage device) to multiple host systems via respective ports of the memory sub-system. The disclosed techniques can enable the memory sub-system to negotiate independently with each host system the allocation of a respective HMB on each host system. The disclosed techniques can then store an association of each port and the corresponding HMB to utilize the appropriate HMB to perform one or more memory operations. By utilizing storage allocated by multiple host systems on respective HMBs, a greater amount of temporary storage becomes available for performing memory operations independently for each host system which can reduce access times and improves the overall efficiencies of the memory sub-system.

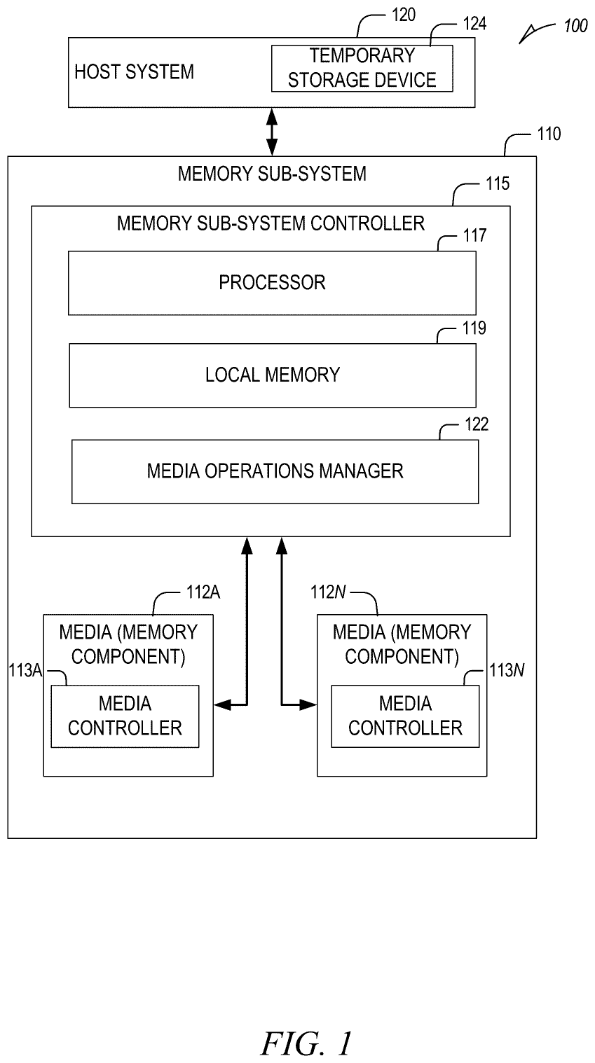

A memory sub-system can be a storage device, a memory module, or a hybrid of a storage device and memory module. Examples of storage devices and memory modules are described below in conjunction with FIG. 1. In general, a host system can utilize a memory sub-system that includes one or more memory components, such as memory devices (e.g., memory dies or planes across multiple memory dies) that store data. The host system can send access requests (e.g., write command, read command) to the memory sub-system, such as to store data at the memory sub-system and to read data from the memory sub-system. The data (or set of data) specified by the host is hereinafter referred to as “host data,” “application data,” or “user data.”

The memory sub-system can initiate media management operations (also referred to as backend operations), such as a write operation, on host data that is stored on a memory device. For example, firmware of the memory sub-system may re-write previously written host data from a location on a memory device to a new location as part of garbage collection management operations. The data that is re-written, for example as initiated by the firmware, is hereinafter referred to as “garbage collection data.” “User data” can include host data and garbage collection data. “System data” hereinafter refers to data that is created and/or maintained by the memory sub-system for performing operations in response to host requests and for media management. Examples of system data include, and are not limited to, system tables (e.g., logical-to-physical address mapping table), data from logging, scratch pad data, etc.

Many different media management operations can be performed on the memory device. For example, the media management operations can include different scan rates, different scan frequencies, different wear leveling, different read disturb management, different near miss error correction (ECC), and/or different dynamic data refresh. Wear leveling ensures that all blocks in a memory component approach their defined erase-cycle budget at the same time, rather than some blocks approaching it earlier. Read disturb management counts all of the read operations to the memory component. If a certain threshold is reached, the surrounding regions are refreshed. Near-miss ECC refreshes all data read by the application that exceeds a configured threshold of errors. Dynamic data-refresh scan reads all data and identifies the error status of all blocks as a background operation. If a certain threshold of errors per block or ECC unit is exceeded in this scan-read, a refresh operation is triggered.

A memory device can be a non-volatile memory device. A non-volatile memory device is a package of one or more dice (or dies). Each die can be comprised of one or more planes. For some types of non-volatile memory devices (e.g., NAND devices), each plane is comprised of a set of physical blocks. For some memory devices, blocks are the smallest area than can be erased. Such blocks can be referred to or addressed as logical units (LUN). Each block is comprised of a set of pages. Each page is comprised of a set of memory cells, which store bits of data. The memory devices can be raw memory devices (e.g., NAND), which are managed externally, for example, by an external controller. The memory devices can be managed memory devices (e.g., managed NAND), which is a raw memory device combined with a local embedded controller for memory management within the same memory device package.

Some SSDs (e.g., memory sub-systems) that exclude a DRAM are referred to as DRAM-less SSDs. In such systems, configuration data and various other system information, such as logical to physical address maps/tables, are stored on a specified portion of a DRAM of a host. This specified portion is usually referred to as the HMB. Memory sub-systems that include local temporary storage devices (e.g., DRAM or SRAM) (referred to as DRAM-enabled SSDs) have no need for the HMB. Such systems store the configuration information and various other system information locally on the DRAM or the SRAM. Because the DRAM-enabled SSDs do not utilize the HMB, such storage resources are wasted. This waste becomes even more pronounced in such systems that are coupled to multiple host systems using multiple ports of the memory sub-system, such as in automotive applications (e.g., automotive SSDs). Such multiple host systems in automotive SSD environments can include an In-Vehicle Infotainment (IVI) system, an Advanced Driver-Assistance System (ADAS) and/or an automotive telemetric system.

Ensuring that automotive SSDs perform efficiently and do not pose unacceptable risks due to hazards caused by malfunctioning behavior is paramount. Multi-port memory systems, which allow multiple processors or controllers to access the same memory simultaneously, can introduce inefficiencies in automotive applications, particularly when it comes to managing Flash Translation Layers (FTLs) across multiple hosts. These inefficiencies can significantly impact system performance and resource utilization, leading to potential bottlenecks and increased operational costs. In automotive systems, where reliability and real-time processing are critical, the management of FTLs across multiple hosts in a multi-port memory setup can lead to complex synchronization issues. Each host connected to the multi-port memory may need to maintain its own view of the FTL, which maps logical addresses to physical addresses in the NAND flash memory. This setup is necessary because automotive systems often involve diverse applications running concurrently, requiring access to shared data storage. However, maintaining consistent FTLs across different hosts can be challenging. The need for constant updates and synchronization of FTLs whenever data is written to or erased from the memory can introduce latency. This is because each change in the memory may need to be communicated and reconciled across all hosts to ensure data integrity and prevent corruption.

Moreover, this synchronization requirement can lead to inefficient use of computational and memory resources. The overhead of managing multiple FTLs can consume significant processing power and memory bandwidth, which could otherwise be used for critical automotive functions such as navigation, autonomous driving computations, or real-time sensor data processing. Additionally, the complexity of ensuring accurate and synchronized FTLs across multiple hosts increases the likelihood of errors. These errors can trigger recovery processes, further slowing down the system and consuming resources. In worst-case scenarios, inconsistencies in FTL management could lead to system failures, compromising vehicle safety and functionality.

Examples of the present disclosure address the above and other deficiencies by providing a memory controller that can leverage separate and exclusive HMBs for each host system that is coupled to the memory sub-system for performing memory operations. Specifically, the memory controller can negotiate independently with each host system to establish the allocation of a respective HMB on each host system. The memory controller can then store an association of each port and the corresponding HMB to utilize the appropriate HMB to perform one or more memory operations. By utilizing storage allocated by multiple host systems on respective HMBs, a greater amount of temporary storage becomes available for performing memory operations independently for each host system which can reduce access times and improve the overall efficiencies of the memory sub-system. This increases the overall amount of storage resources available to the memory sub-system, which increases the overall efficiency of the device.

Specifically, the disclosed techniques can associate, with a first port of the memory sub-system, a first HMB of a first temporary storage device (e.g., DRAM) that has been allocated to the memory sub-system by a first host system of a plurality of host systems. The disclosed techniques can associate, with a second port of the memory sub-system, a second HMB of a second temporary storage device that has been allocated to the memory sub-system by a second host system of the plurality of host systems. The disclosed techniques can perform one or more memory operations on user data using the first HMB and the second HMB and the set of memory components. The first port and the second port can be part of a plurality of ports of the memory sub-system, a respective single HMB of a temporary storage device being associated with one of the plurality of ports. The controller can utilize the first HMB to store and manage working data for the at least one processing device including mapping L2P tables for data and commands received through the first port from the first host system. The controller can utilize the second HMB to store and manage working data for the at least one processing device including mapping L2P tables for data and commands received through the second port from the second host system.

In some examples, the first and second temporary storage devices each include a DRAM device. The disclosed techniques can store FTL data associated with requests received, via the first port, from the first host system on the first HMB. The disclosed techniques can store additional FTL data associated with requests received, via the second port, from the second host system on the second HMB. In some cases, the disclosed techniques negotiate, via the first port, allocation of the first HMB on the first host system and negotiate, via the second port, allocation of the second HMB on the second host system.

In some examples, the first HMB is of a different size than the second HMB. The disclosed techniques use the first HMB to exclusively buffer and reorder data and commands received through the first port from the first host system and use the second HMB to exclusively buffer and reorder data and commands received through the second port from the second host system. In some cases, the first and second ports are included as part of an internal switch component (or fabric) of the memory sub-system.

The disclosed techniques determine that a memory operation command has been received via the first port and, in response to determining that the memory operation command has been received via the first port, access the first HMB on the first host system to complete the memory operation command. The disclosed techniques receive, from the first host system, a request to program the user data and store, on a first portion of the first HMB, a mapping between a set of logical addresses associated with the request and a set of physical addresses on the set of memory components. In some examples, the disclosed techniques cache, on a second portion of the first HMB, the user data prior to programming the user data to the set of physical addresses on the set of memory components. In some cases, the disclosed techniques delete the user data from the second portion of the HMB after programming the user data to the set of physical addresses on the set of memory components. In some cases, the first host system includes an IVI system (or first system-on-chip) and the second host system includes an ADAS or an automotive telemetric system or (second system-on-chip). Each system-on-chip being operatively connected to the memory sub-system for data communication and processing.

Though various examples are described herein as being implemented with respect to a memory sub-system (e.g., a controller of the memory sub-system), some or all of the portions of an example can be implemented with respect to a host system, such as a software application or an operating system of the host system.

FIG. 1 illustrates an example computing environment 100 including a memory sub-system 110, in accordance with some examples of the present disclosure. The memory sub-system 110 can include media, such as memory components 112A to 112N (also hereinafter referred to as “memory devices”). The memory components 112A to 112N can be volatile memory devices, non-volatile memory devices, or a combination of such. The memory components 112A to 112N can be implemented by individual dies, such that a first memory component 112A can be implemented by a first memory die (or a first collection of memory dies) and a second memory component 112N can be implemented by a second memory die (or a second collection of memory dies). Each memory die can include a plurality of planes in which data can be stored or programmed. In some cases, the first memory component 112A can be implemented by a first SSD (or a first independently operable memory sub-system) and the second memory component 112N can be implemented by a second SSD (or a second independently operable memory sub-system).

In some examples, the memory sub-system 110 is a storage system. A memory sub-system 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, and a hard disk drive (HDD). Examples of memory modules include a dual in-line memory module (DIMM), a small outline DIMM (SO-DIMM), and a non-volatile dual in-line memory module (NVDIMM).

The computing environment 100 can include a host system 120 or multiple host systems 120 that is/are coupled to a memory system. The memory system can include one or more memory sub-systems 110. In some examples, the host system(s) 120 is/are coupled to different types of memory sub-system 110. FIG. 1 illustrates one example of a host system 120 coupled to one memory sub-system 110. The host system 120 uses the memory sub-system 110, for example, to write data to the memory sub-system 110 and read data from the memory sub-system 110. As used herein, “coupled to” generally refers to a connection between components, which can be an indirect communicative connection or direct communicative connection (e.g., without intervening components), whether wired or wireless, including connections such as electrical, optical, magnetic, etc.

The host system 120 can be a computing device such as a desktop computer, laptop computer, network server, mobile device, embedded computer (e.g., one included in a vehicle, industrial equipment, or a networked commercial device), or such computing device that includes a memory and a processing device. The host system 120 can include or be coupled to the memory sub-system 110 so that the host system 120 can read data from or write data to the memory sub-system 110. The host system 120 can be coupled to the memory sub-system 110 via a physical host interface, such as a physical respective port of a switching fabric or component of the memory sub-system 110. Examples of a physical host interface or ports include, but are not limited to, a serial advanced technology attachment (SATA) interface, a peripheral component interconnect express (PCIe) interface, a compute express link (CXL), a universal serial bus (USB) interface, a Fibre Channel interface, a Serial Attached SCSI (SAS) interface, etc. The physical host interface can be used to transmit data between the host system 120 and the memory sub-system 110. The host system 120 can further utilize an NVM Express (NVMe) interface to access the memory components 112A to 112N when the memory sub-system 110 is coupled with the host system 120 by the PCIe or CXL interface. The physical host interface can provide an interface for passing control, address, data, and other signals between the memory sub-system 110 and the host system 120. In cases of having multiple host system 120 coupled to the same memory sub-system 110, each host system 120 can communicate with the memory sub-system 110 via a respective one of multiple ports or interfaces.

The host system 120 can include a temporary storage device 124. The temporary storage device 124 can be a volatile storage device, such as DRAM and/or SRAM. The host system 120 can allocate a certain portion of the temporary storage device 124 as an HMB. This certain portion can be used by the memory sub-system 110 to perform various operations and/or to cache user data of the memory sub-system 110. The host system 120 can provide data to the memory sub-system 110 that identifies this certain portion of the temporary storage device 124 that has been allocated for use as the HMB. The data can identify the certain portion by a physical address range. This portion of the temporary storage device 124 can remain unused by the host system 120 during operations. Namely, the portion of the temporary storage device 124 that is allocated to the memory sub-system 110 is exclusively used by the memory sub-system 110 and is not allocated to the operating system of the host system 120 as available memory. The memory sub-system 110 can store the identification of the physical address range that has been allocated by the host system 120 as part of the configuration information. Using this physical address range, the processor 117 can generate a virtual address range that includes the HMB and that also includes physical portions of the local memory 119 (e.g., local volatile and/or non-volatile storage, such as DRAM and/or SRAM).

In some cases, additional host systems 120 can respectively include temporary storage devices 124 which can be used to allocate respective HMBs on the additional host systems 120. For example, a second host system 120 can allocate a certain portion of the temporary storage device 124 as a second HMB. This certain portion can be used by the memory sub-system 110 to perform various operations and/or to cache user data of the memory sub-system 110 corresponding to the second host system 120. The second host system 120 can provide data to the memory sub-system 110 that identifies this certain portion of the temporary storage device 124 that has been allocated for use as the second HMB. The data can identify the certain portion by a physical address range. This portion of the temporary storage device 124 can remain unused by the second host system 120 during operations. Namely, the portion of the temporary storage device 124 that is allocated to the memory sub-system 110 is exclusively used by the memory sub-system 110 and is not allocated to the operating system of the second host system 120 as available memory or any other host system 120. The memory sub-system 110 can store the identification of the physical address range that has been allocated by the second host system 120 as part of the configuration information. Using this physical address range, the processor 117 can generate a virtual address range that includes the second HMB and that also includes physical portions of the local memory 119 (e.g., local volatile and/or non-volatile storage, such as DRAM and/or SRAM).

The memory components 112A to 112N (which are used to implement the storage capabilities of the memory sub-system 110) can include any combination of the different types of non-volatile memory components and/or volatile memory components and/or storage devices. An example of non-volatile memory components includes a negative-and (NAND)-type flash memory. Each of the memory components 112A to 112N can include one or more arrays of memory cells such as single-level cells (SLCs) or multi-level cells (MLCs) (e.g., TLCs or QLCs). In some examples, a particular memory component 112 can include both an SLC portion and an MLC portion of memory cells. Each of the memory cells can store one or more bits of data (e.g., blocks) used by the host system 120. Although non-volatile memory components such as NAND-type flash memory are described, the memory components 112A to 112N can be based on any other type of memory, such as a volatile memory. In some examples, the memory components 112A to 112N can be, but are not limited to, random access memory (RAM), read-only memory (ROM), dynamic random access memory (DRAM), synchronous dynamic random access memory (SDRAM), phase change memory (PCM), magnetoresistive random access memory (MRAM), negative-or (NOR) flash memory, electrically erasable programmable read-only memory (EEPROM), and a cross-point array of non-volatile memory cells.

A cross-point array of non-volatile memory cells can perform bit storage based on a change of bulk resistance, in conjunction with a stackable cross-gridded data access array. Additionally, in contrast to many flash-based memories, cross-point non-volatile memory can perform a write-in-place operation, where a non-volatile memory cell can be programmed without the non-volatile memory cell being previously erased. Furthermore, the memory cells of the memory components 112A to 112N can be grouped as memory pages or blocks that can refer to a unit of the memory component 112 used to store data. For example, a single first row that spans a first set of the pages or blocks of the memory components 112A to 112N can correspond to or be grouped as a first block stripe and a single second row that spans a second set of the pages or blocks of the memory components 112A to 112N can correspond to or be grouped as a second block stripe.

The memory sub-system controller 115 can communicate with the memory components 112A to 112N to perform memory operations such as reading data, writing data, or erasing data at the memory components 112A to 112N and other such operations. The memory sub-system controller 115 can communicate with the memory components 112A to 112N to perform various memory management operations (also referred to as back-end operations), such as different scan rates, different scan frequencies, different wear leveling, different read disturb management, garbage collection operations, different near miss ECC operations, and/or different dynamic data refresh. In some cases, the memory sub-system controller 115 can utilize the virtual address range to selectively and/or dynamically control whether system data and/or user data is stored on the local memory 119 of the memory sub-system 110 and/or the temporary storage device 124 of the host system 120.

The memory sub-system controller 115 can include hardware, such as one or more integrated circuits and/or discrete components, a buffer memory, or a combination thereof. The memory sub-system controller 115 can be a microcontroller, special-purpose logic circuitry (e.g., a field programmable gate array (FPGA), an application-specific integrated circuit (ASIC), etc.), or another suitable processor. The memory sub-system controller 115 can include a processor (processing device) 117 configured to execute instructions stored in local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120. In some examples, the local memory 119 can include memory registers storing memory pointers, fetched data, and so forth. The local memory 119 can also include read-only memory (ROM) for storing microcode. While the example memory sub-system 110 in FIG. 1 has been illustrated as including the memory sub-system controller 115, in another example of the present disclosure, a memory sub-system 110 may not include a memory sub-system controller 115, and can instead rely upon external control (e.g., provided by an external host, or by a processor 117 or controller separate from the memory sub-system 110).

The local memory 119 can include one or more volatile and/or non-volatile memory devices. For example, the local memory 119 can include a DRAM storage device and/or an SRAM storage device. The local memory 119 can store configuration data for the memory sub-system controller 115 and can store a logical to physical address map or table. In some cases, the local memory 119 can be used by the memory sub-system controller 115 as a cache for data that is going to be programmed to the set of memory components 112A to 112N. Specifically, a request can be received from the host system 120 to program a set of data. In response, the memory sub-system controller 115 can update a logical-to-physical address association in the logical-to-physical address map or table stored in the local memory 119. The memory sub-system controller 115 can also store the set of data in a cache of the local memory 119. At some later point in time, the memory sub-system controller 115 can transfer the set of data from the cache of the local memory 119 to one or more physical locations of the set of memory components 112A to 112N. In some cases, the memory sub-system controller 115 can use the virtual address space to also store or cache the set of data to the HMB of the temporary storage device 124. In such cases, the set of data can be cached in two places at the same time (e.g., on the local memory 119 and on the HMB of the temporary storage device 124). After the data is stored or programmed to the set of memory components 112A to 112N, the memory sub-system controller 115 can delete or remove the data from the cache of the local memory 119 but retain or prevent deletion of that same data from the HMB of the temporary storage device 124. This can enable faster retrieval of the data if the data is subsequently requested to be retrieved or read by the host system 120 as such data can be read from the temporary storage device 124 without accessing the set of memory components 112A to 112N.

In general, the memory sub-system controller 115 can receive commands or operations from the host system 120 and can convert the commands or operations into instructions or appropriate commands to achieve the desired access to the memory components 112A to 112N. In some examples, the commands or operations received from the host system 120 can specify configuration data for the memory components 112A to 112N. The configuration data can describe the lifetime (maximum) PEC values and/or reliability grades associated with different groups of the memory components 112A to 112N and/or different blocks within each of the memory components 112A to 112N of each memory component used to implement the memory sub-system. For example, the memory sub-system may be made up of three memory components (e.g., three SSDs).

The memory sub-system controller 115 can be responsible for other memory management operations, such as wear leveling operations, garbage collection operations, error detection and error-correcting code (ECC) operations, encryption operations, caching operations, and address translations. The memory sub-system controller 115 can further include host interface circuitry to communicate with the host system 120 via the physical host interface. The host interface circuitry can convert the commands received from the host system 120 into command instructions to access the memory components 112A to 112N as well as convert responses associated with the memory components 112A to 112N into information for the host system 120.

The memory sub-system 110 can also include additional circuitry or components that are not illustrated. In some examples, the memory sub-system 110 can include a cache or buffer (e.g., DRAM or other temporary storage location or device) and address circuitry (e.g., a row decoder and a column decoder) that can receive an address from the memory sub-system controller 115 and decode the address to access the memory components 112A to 112N. This cache or buffer can be part of the local memory 119 (as mentioned above) or can be a wholly and entirely or partially separate physical component.

The memory devices can be raw memory devices (e.g., NAND), which are managed externally, for example, by an external controller (e.g., memory sub-system controller 115). The memory devices can be managed memory devices (e.g., managed NAND), which is a raw memory device combined with a local embedded controller (e.g., local media controllers) for memory management within the same memory device package. Any one of the memory components 112A to 112N can include a media controller (e.g., media controller 113A and media controller 113N) to manage the memory cells of the memory component (e.g., to perform one or more memory management operations), to communicate with the memory sub-system controller 115, and to execute memory requests (e.g., read or write) received from the memory sub-system controller 115.

Depending on the example, the media operations manager 122 can comprise logic (e.g., a set of transitory or non-transitory machine instructions, such as firmware) or one or more components that causes the media operations manager 122 to perform operations described herein. The media operations manager 122 can comprise a tangible or non-tangible unit capable of performing operations described herein.

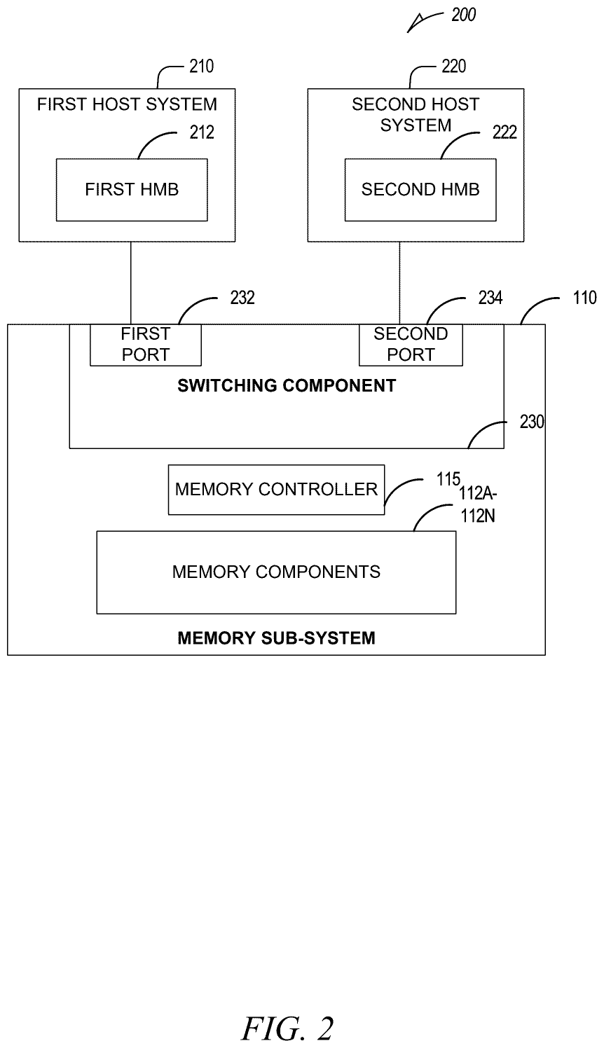

FIG. 2 is a block diagram of an example multi-port memory sub-system 200 (corresponding to computing environment 100), in accordance with some examples. The multi-port memory sub-system 200 includes a first host system 210 and a second host system 220. The multi-port memory sub-system 200 can include many more host systems than the two that are shown in FIG. 2. In some cases, the first host system 210 can correspond to or implement one or more of an IVI system, an ADAS, and/or an automotive telemetric system. The second host system 220 can correspond to or implement a different one or more of an IVI system, an ADAS, and/or an automotive telemetric system than that implemented by the first host system 210 or can be duplicative of the first host system 210.

In some examples, the first host system 210 communicates with the memory sub-system 110 via a switching component 230, such as a first physical port 232 of the switching component 230 of the memory sub-system 110. The first physical port 232 can include any one of the host interface devices mentioned above, such as a SATA interface, a PCIe interface, NVMe interface, a CXL, a USB interface, a Fibre Channel interface, a SAS interface, etc. The second host system 220 communicates with the memory sub-system 110 via the switching component 230, such as a second physical port 234 of the switching component 230 of the memory sub-system 110. The second physical port 234 can include any one of the host interface devices mentioned above, such as a SATA interface, a PCIe interface, NVMe interface, a CXL, a USB interface, a Fibre Channel interface, a SAS interface, etc. In some cases, the first physical port 232 and the second physical port 234 can be the same physical interface over which communications between the memory sub-system 110 and the first host system 210 and second host system 220 are multiplexed in time and/or frequency.

The memory sub-system controller 115 can negotiate with the first host system 210 during an initialization operation via the first physical port 232 to setup and allocate the first HMB 212 on the first host system 210. The first HMB 212 can be allocated on the temporary storage device 124 of the first host system 210. The negotiation can establish the size and physical address space of the temporary storage device 124 that will be used to provide or allocate the first HMB 212. After the first HMB 212 is allocated, the memory sub-system controller 115 can utilize the first HMB 212 as additional temporary storage to store user data, configuration data, and/or FTL information associated with commands received from the first host system 210. Similarly, memory sub-system controller 115 can negotiate with the second host system 220 during an initialization operation via the second physical port 234 to setup and allocate the second HMB 222 on the second host system 220. The second HMB 222 can be allocated on the temporary storage device 124 of the second host system 220. The negotiation can establish the size and physical address space of the temporary storage device 124 that will be used to provide or allocate the second HMB 222. After the second HMB 222 is allocated, the memory sub-system controller 115 can utilize the second HMB 222 as additional temporary storage to store user data, configuration data, and/or FTL information associated with commands received from the second host system 220.

In some examples, the memory sub-system controller 115 can store a local map that associates the first physical port 232 with the physical storage locations that define the first HMB 212 and can associate the second physical port 234 with the physical storage locations that define the second HMB 222. This way, when the memory sub-system controller 115 receives one or more commands from the first physical port 232, the memory sub-system controller 115 can access the map to find the physical address locations of the first HMB 212 and to retrieve and/or access metadata, user data, and/or FTL data stored by the first HMB 212. Similarly, when the memory sub-system controller 115 receives one or more commands from the second physical port 234, the memory sub-system controller 115 can access the map to find the physical address locations of the second HMB 222 and to retrieve and/or access metadata, user data, and/or FTL data stored by the second HMB 222. The FTL data can store a mapping between a set of logical addresses associated with host requests and a set of physical addresses on the set of memory components 112A to 112N.

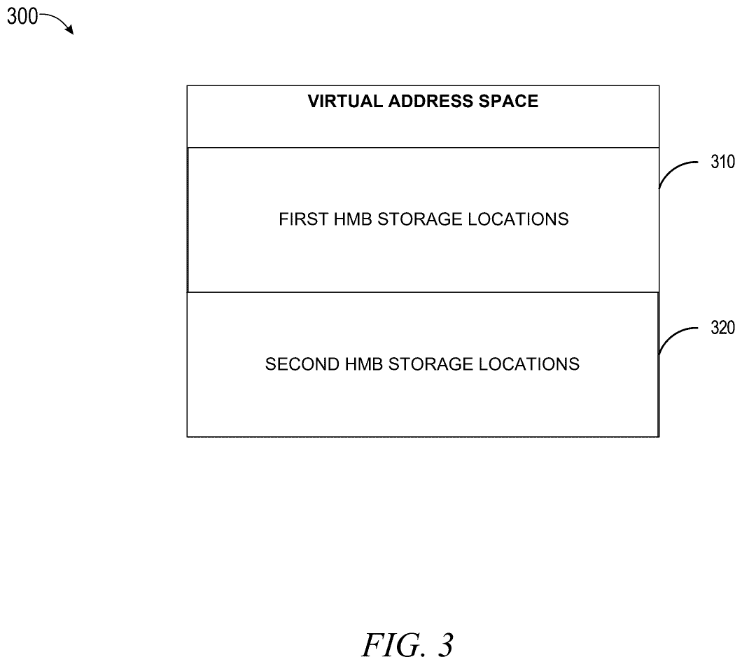

Specifically, the memory sub-system controller 115 can store the virtual address space 300, shown in FIG. 3. The virtual address space 300 can identify the first HMB storage locations 310 that make up the first HMB 212. The virtual address space 300 can identify the second HMB storage locations 320 that make up the second HMB 222. The virtual address space 300 can also associate each of the first HMB storage locations 310 and the second HMB storage locations 320 with the respective port of the switching component 230. For example, the first HMB storage locations 310 can be associated with the first physical port 232 and the second HMB storage locations 320 can be associated with the second physical port 234. In response to receiving a command from the second physical port 234, the memory sub-system controller 115 can access the virtual address space 300 to retrieve the second HMB storage locations 320 associated with the second physical port 234. Using the second HMB storage locations 320, the memory sub-system controller 115 can identify the physical storage locations of the second HMB 222 that has been allocated for the second host system 220 on the second physical port 234.

The memory sub-system controller 115 can use the first HMB storage locations 310 to exclusively buffer and reorder data and commands received through the first physical port 232 from the first host system 210. The memory sub-system controller 115 can use the second HMB storage locations 320 to exclusively buffer and reorder data and commands received through the second physical port 234 from the second host system 220.

In some examples, the memory sub-system controller 115 can receive, from the first host system 210, a request to program a first set of user data. In response, the memory sub-system controller 115 identifies the first HMB 212 associated with the first host system 210 and stores, on a first portion of the first HMB 212, a first mapping between a first set of logical addresses associated with the request to program the first set of user data and a first set of physical addresses on the set of memory components 112A to 112N. In parallel, memory sub-system controller 115 can receive, from the second host system 220, a request to program a second set of user data. In response, the memory sub-system controller 115 identifies the second HMB 222 associated with the second host system 220 and stores, on a first portion of the second HMB 222, a first mapping between a second set of logical addresses associated with the request to program the second set of user data and a second set of physical addresses on the set of memory components 112A to 112N.

In some examples, the memory sub-system controller 115 caches, on a second portion of the first HMB 212, the first set of user data prior to programming the user data to the first set of physical addresses on the set of memory components. The memory sub-system controller 115 caches, on a second portion of the second HMB 222, the second set of user data prior to programming the second set of user data to the second set of physical addresses on the set of memory components. After the memory sub-system controller 115 programs the first and/or second sets of user data to the set of memory components 112A to 112N, the memory sub-system controller 115 deletes the user data from one or more of the second portions of the first/second HMB 212/222.

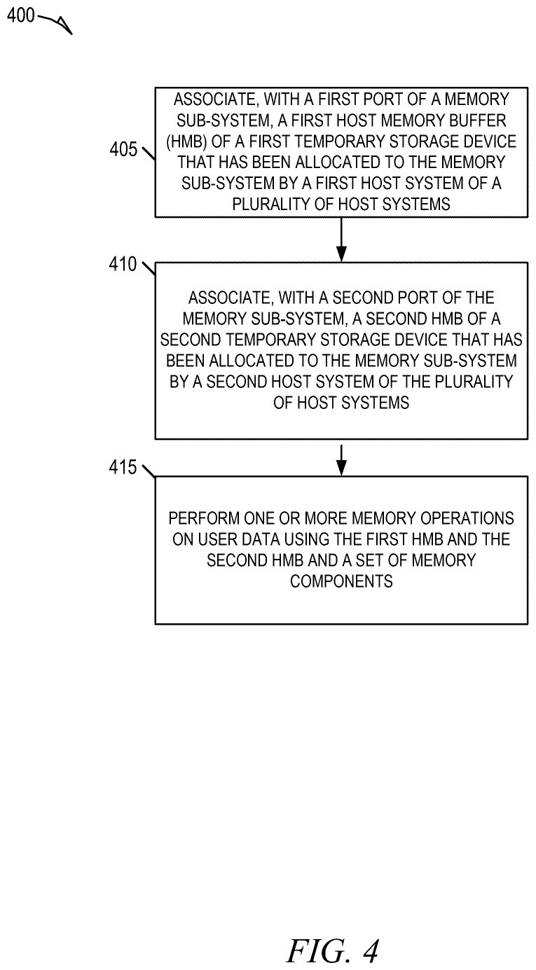

FIG. 4 is a flow diagram of an example method 400, in accordance with some implementations of the present disclosure. The method 400 can be performed by processing logic that can include hardware (e.g., a processing device, circuitry, dedicated logic, programmable logic, microcode, hardware of a device, an integrated circuit, etc.), software (e.g., instructions run or executed on a processing device), or a combination thereof. In some examples, the method 400 is performed by the media operations manager 122 of FIG. 1. Although the processes are shown in a particular sequence or order, unless otherwise specified, the order of the processes can be modified. Thus, the illustrated examples should be understood only as examples, and the illustrated processes can be performed in a different order, and some processes can be performed in parallel. Additionally, one or more processes can be omitted in various examples. Thus, not all processes are required in every example. Other process flows are possible.

Referring now to FIG. 4, the method (or process) 400 begins at operation 405, with a media operations manager 122 of a memory sub-system (e.g., memory sub-system 110) associating, with a first port of the memory sub-system, a first HMB of a first temporary storage device that has been allocated to the memory sub-system by a first host system of a plurality of host systems. Then, at operation 410, the media operations manager 122 associates, with a second port of the memory sub-system, a second HMB of a second temporary storage device that has been allocated to the memory sub-system by a second host system of the plurality of host systems. At operation 415, the media operations manager 122 performing one or more memory operations on user data using the first HMB and the second HMB and the set of memory components 112A to 112N.

In view of the disclosure above, various examples are set forth below. It should be noted that one or more features of an example, taken in isolation or combination, should be considered within the disclosure of this application.

Example 1: A memory sub-system comprising: a set of memory components; and at least one processing device operatively coupled to the set of memory components, the at least one processing device being configured to perform operations comprising: associating, with a first port of the memory sub-system, a first host memory buffer (HMB) of a first temporary storage device, the first HMB being allocated to the memory sub-system by a first host system of a plurality of host systems; associating, with a second port of the memory sub-system, a second HMB of a second temporary storage device, the second HMB being allocated to the memory sub-system by a second host system of the plurality of host systems; and performing one or more memory operations on user data using the first HMB, the second HMB, and the set of memory components.

Example 2. The memory sub-system of Example 1, wherein the first and the second temporary storage devices each comprise a DRAM device, and wherein the first and second HMBs are allocated in virtual address space of the at least one processing device.

Example 3. The memory sub-system of any one of Examples 1-2, wherein the operations comprise storing, on the first HMB, flash translation layer (FTL) data associated with requests received from the first host system via the first port.

Example 4. The memory sub-system of any one of Examples 1-3, wherein the operations comprise storing, on the second HMB, additional FTL data associated with requests received from the second host system via the second port.

Example 5. The memory sub-system of any one of Examples 1-4, wherein the operations comprise: negotiating, via the first port, allocation of the first HMB on the first host system; and negotiating, via the second port, allocation of the second HMB on the second host system.

Example 6. The memory sub-system of any one of Examples 1-5, wherein the first HMB has a different size than the second HMB, wherein a size of the first HMB is allocated based on negotiating the allocation of the first HMB.

Example 7. The memory sub-system of any one of Examples 1-6, wherein the operations comprise: using the first HMB to exclusively buffer and reorder data and commands received through the first port from the first host system; and using the second HMB to exclusively buffer and reorder data and commands received through the second port from the second host system.

Example 8. The memory sub-system of any one of Examples 1-7, wherein the first and second ports are included as part of an internal switch component of the memory sub-system.

Example 9. The memory sub-system of any one of Examples 1-8, wherein the operations comprise: determining that a memory operation command has been received via the first port; and in response to determining that the memory operation command has been received via the first port, accessing the first HMB on the first host system to complete the memory operation command.

Example 10. The memory sub-system of Example 9, wherein the operations comprise: receiving, from the first host system, a request to program the user data; and storing, on a first portion of the first HMB, a mapping between a set of logical addresses associated with the request and a set of physical addresses on the set of memory components.

Example 11. The memory sub-system of Example 10, wherein the operations comprise: caching, on a second portion of the first HMB, the user data prior to programming the user data to the set of physical addresses on the set of memory components.

Example 12. The memory sub-system of Example 11, wherein the operations comprise: deleting the user data from the second portion of the first HMB after programming the user data to the set of physical addresses on the set of memory components.

Example 13. The memory sub-system of any one of Examples 1-12, wherein the first host system comprises an In-Vehicle Infotainment (IVI) system, and wherein the second host system comprises at least one of an Advanced Driver-Assistance System (ADAS) or an automotive telemetric system.

Example 14. The memory sub-system of any one of Examples 1-13, wherein the first host system comprises a first computing device with a first system-on-chip, and the second host system comprises a second computing device with a second system-on-chip, each system-on-chip being operatively connected to the memory sub-system for data communication and processing.

Example 15. The memory sub-system of any one of Examples 1-14, wherein the first port and the second port are part of a plurality of ports of the memory sub-system, a respective single HMB of a temporary storage device being associated with one of the plurality of ports.

Example 16. The memory sub-system of any one of Examples 1-15, wherein the operations comprise: utilizing the first HMB to store and manage working data for the at least one processing device including mapping L2P tables for data and commands received through the first port from the first host system; and utilizing the second HMB to store and manage working data for the at least one processing device including mapping L2P tables for data and commands received through the second port from the second host system.

Methods and computer-readable storage medium with instructions for performing any one of the above Examples.

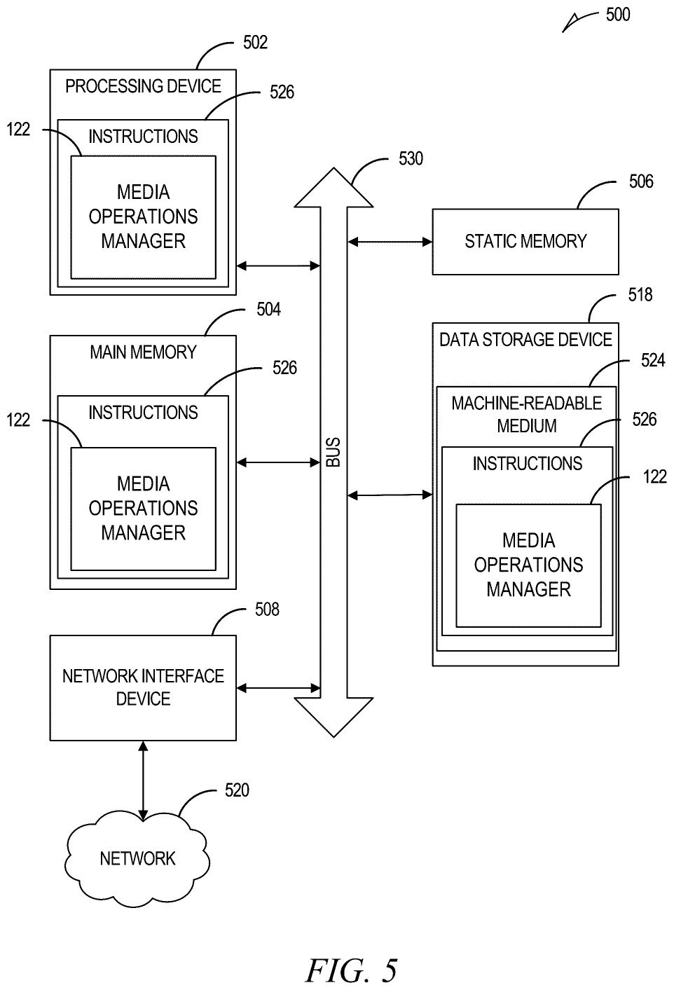

FIG. 5 illustrates an example machine in the form of a computer system 500 within which a set of instructions can be executed for causing the machine to perform any one or more of the methodologies discussed herein. In some examples, the computer system 500 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the media operations manager 122 of FIG. 1). In alternative examples, the machine can be connected (e.g., networked) to other machines in a local area network (LAN), an intranet, an extranet, and/or the Internet. The machine can operate in the capacity of a server or a client machine in a client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a network switch, a network bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 500 includes a processing device 502, a main memory 504 (e.g., read-only memory (ROM), flash memory, dynamic random access memory (DRAM) such as synchronous DRAM (SDRAM) or Rambus DRAM (RDRAM), etc.), a static memory 506 (e.g., flash memory, static random access memory (SRAM), etc.), and a data storage system 518, which communicate with each other via a bus 530.

The processing device 502 represents one or more general-purpose processing devices such as a microprocessor, a central processing unit, or the like. More particularly, the processing device 502 can be a complex instruction set computing (CISC) microprocessor, a reduced instruction set computing (RISC) microprocessor, a very long instruction word (VLIW) microprocessor, a processor implementing other instruction sets, or processors implementing a combination of instruction sets. The processing device 502 can also be one or more special-purpose processing devices such as an application specific integrated circuit (ASIC), a field programmable gate array (FPGA), a digital signal processor (DSP), a network processor, or the like. The processing device 502 is configured to execute instructions 526 for performing the operations and steps discussed herein. The computer system 500 can further include a network interface device 508 to communicate over a network 520.

The data storage system 518 can include a machine-readable storage medium 524 (also known as a computer-readable medium) on which is stored one or more sets of instructions 526 or software embodying any one or more of the methodologies or functions described herein. The instructions 526 can also reside, completely or at least partially, within the main memory 504 and/or within the processing device 502 during execution thereof by the computer system 500, the main memory 504 and the processing device 502 also constituting machine-readable storage media. The machine-readable storage medium 524, data storage system 518, and/or main memory 504 can correspond to the memory sub-system 110 of FIG. 1.

In one example, the instructions 526 implement functionality corresponding to the media operations manager 122 of FIG. 1. While the machine-readable storage medium 524 is shown in an example to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system's memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. Such a computer program can be stored in a computer-readable storage medium, such as, but not limited to, any type of disk including floppy disks, optical disks, CD-ROMs, and magnetic-optical disks; read-only memories (ROMs); random access memories (RAMs); erasable programmable read-only memories (EPROMs); EEPROMs; magnetic or optical cards; or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description above. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some examples, a machine-readable (e.g., computer-readable) medium includes a machine-readable (e.g., computer-readable) storage medium such as a read-only memory (ROM), random access memory (RAM), magnetic disk storage media, optical storage media, flash memory components, and so forth.

In the foregoing specification, the disclosure has been described with reference to specific examples thereof. It will be evident that various modifications can be made thereto without departing from the broader scope of the disclosure as set forth in the following claims. The specification and drawings are, accordingly, to be regarded in an illustrative sense rather than a restrictive sense.

What is claimed is:

1. A memory sub-system comprising:
a set of memory components; and
at least one processing device operatively coupled to the set of memory components, the at least one processing device being configured to perform operations comprising:
associating, with a first port of the memory sub-system, a first host memory buffer (HMB) of a first temporary storage device, the first HMB being allocated to the memory sub-system by a first host system of a plurality of host systems;
associating, with a second port of the memory sub-system, a second HMB of a second temporary storage device, the second HMB being allocated to the memory sub-system by a second host system of the plurality of host systems; and
performing one or more memory operations on user data using the first HMB, the second HMB, and the set of memory components.

2. The memory sub-system of claim 1, wherein the first and the second temporary storage devices each comprise a DRAM device, and wherein the first HMB and the second HMB are allocated in virtual address space of the at least one processing device.

3. The memory sub-system of claim 1, wherein the operations comprise storing, on the first HMB, flash translation layer (FTL) data associated with requests received from the first host system via the first port.

4. The memory sub-system of claim 1, wherein the operations comprise storing, on the second HMB, additional FTL data associated with requests received from the second host system via the second port.

5. The memory sub-system of claim 1, wherein the operations comprise:
negotiating, via the first port, allocation of the first HMB on the first host system; and
negotiating, via the second port, allocation of the second HMB on the second host system.

6. The memory sub-system of claim 1, wherein the first HMB has a different size than the second HMB, wherein a size of the first HMB is allocated based on negotiating the allocation of the first HMB.

7. The memory sub-system of claim 1, wherein the operations comprise:
using the first HMB to exclusively buffer and reorder data and commands received through the first port from the first host system; and
using the second HMB to exclusively buffer and reorder data and commands received through the second port from the second host system.

8. The memory sub-system of claim 1, wherein the first and second ports are included as part of an internal switch component of the memory sub-system.

9. The memory sub-system of claim 1, wherein the operations comprise:
determining that a memory operation command has been received via the first port; and
in response to determining that the memory operation command has been received via the first port, accessing the first HMB on the first host system to complete the memory operation command.

10. The memory sub-system of claim 9, wherein the operations comprise:
receiving, from the first host system, a request to program the user data; and
storing, on a first portion of the first HMB, a mapping between a set of logical addresses associated with the request and a set of physical addresses on the set of memory components.

11. The memory sub-system of claim 10, wherein the operations comprise:
caching, on a second portion of the first HMB, the user data prior to programming the user data to the set of physical addresses on the set of memory components.

12. The memory sub-system of claim 11, wherein the operations comprise:
deleting the user data from the second portion of the first HMB after programming the user data to the set of physical addresses on the set of memory components.

13. The memory sub-system of claim 1, wherein the first host system comprises an In-Vehicle Infotainment (IVI) system, and wherein the second host system comprises at least one of an Advanced Driver-Assistance System (ADAS) or an automotive telemetric system.

14. The memory sub-system of claim 1, wherein the first host system comprises a first computing device with a first system-on-chip, and the second host system comprises a second computing device with a second system-on-chip, each system-on-chip being operatively connected to the memory sub-system for data communication and processing.

15. The memory sub-system of claim 1, wherein the first port and the second port are part of a plurality of ports of the memory sub-system, a respective single HMB of a temporary storage device being associated with one of the plurality of ports.

16. The memory sub-system of claim 1, wherein the operations comprise:
utilizing the first HMB to store and manage working data for the at least one processing device including mapping L2P tables for data and commands received through the first port from the first host system; and
utilizing the second HMB to store and manage working data for the at least one processing device including mapping L2P tables for data and commands received through the second port from the second host system.

17. A method comprising:
associating, with a first port of a memory sub-system, a first host memory buffer (HMB) of a first temporary storage device, the first HMB being allocated to the memory sub-system by a first host system of a plurality of host systems;
associating, with a second port of the memory sub-system, a second HMB of a second temporary storage device, the second HMB being allocated to the memory sub-system by a second host system of the plurality of host systems; and
performing one or more memory operations on user data using the first HMB, the second HMB, and a set of memory components.

18. The method of claim 17, comprising storing, on the second HMB, additional FTL data associated with requests received from the second host system via the second port.

19. The method of claim 17, comprising:
negotiating, via the first port, allocation of the first HMB on the first host system; and
negotiating, via the second port, allocation of the second HMB on the second host system.

20. A non-transitory computer-readable storage medium comprising instructions that, when executed by at least one processing device, cause the at least one processing device to perform operations comprising:
associating, with a first port of a memory sub-system, a first host memory buffer (HMB) of a first temporary storage device, the first HMB being allocated to the memory sub-system by a first host system of a plurality of host systems;
associating, with a second port of the memory sub-system, a second HMB of a second temporary storage device, the second HMB being allocated to the memory sub-system by a second host system of the plurality of host systems; and
performing one or more memory operations on user data using the first HMB, the second HMB, and a set of memory components.
